(19) United States
(12) Patent Application Publication
(10) Pub. No.: US 2006/0282539 A1
(43) Pub. Date: Dec. 14, 2006

(54) Method and apparatus for conveying data through an ethernet port

(75) Inventors: Roger Karam, Mountain View, CA (US); Mark Baugher, Portland, OR (US); John F. Wakerly, Oakbrook Terrace, IL (US)

Correspondence Address: LAW OFFICE OF CHARLES E. KRUEGER, P.O. BOX 5607, WALNUT CREEK, CA, 94596-1607, US

(73) Assignee: Cisco Technology, Inc. (A California Corporation)

(21) Appl. No.: 11/152,720

(22) Filed: Jun. 14, 2005

(51) Int. Cl. G06F 15/16

(52) U.S. Cl. 709/228

(57) ABSTRACT

In one embodiment, a non-powered, non-ethernet device can be plugged into an ethernet port of a host to transfer data stored on the device to the host.

### BACKGROUND OF THE INVENTION

The problem of security bootstrapping is acute for a wireless device that has access to multiple wireless base stations without obvious means for selecting one over the other, which frequently occurs in dense neighborhoods where wireless signals overlap. Today, the vast majority of wireless devices in homes are not secure owing to the challenges faced in configuring security in network equipment.

For example, a consumer might own a video library device and a television both having wireless ports. However, if the consumer activates the wireless port on the video library without security then unknown parties could access the content of the library.

Smart cards and similar devices serve to bootstrap a security association as well as to authenticate employees, users and households in consumer electronics and enterprise-security applications. Unfortunately, devices such as the CableCard and other types of smart cards typically require a special-purpose reader, which makes them very expensive by consumer-electronic standards. Authentication “dongles” are hardware devices, containing memory, that attach to a computer port to control access to a particular application or applications. Dongles that attach to computer USB ports are known in the art, but network devices frequently lack a USB port.

For example, the Windows XP Smart Network manufactured by Microsoft Corporation utilizes a flash memory plugged into a USB port to store a 26-digit hex number. The user may use the USB flash drive to add network settings to other devices and must plug the USB flash drive into the access point of any other devices (PCs, notebooks, printers, scanners) to be added to the network and then bring the USB flash drive back to the original PC. Each device writes a small file to the USB flash drive and the USB flash drive drops all the information on the original PC when inserted into its USB port, allowing the original PC to recognize all devices on the network.

The challenges in the field of network security continue to increase with demands for more and better techniques having greater flexibility and adaptability. Therefore, a need has arisen for a new low-cost system and method for providing for secure transaction devices without adding special ports or readers to the device.

### BRIEF DESCRIPTION OF THE DRAWINGS

FIG. 1A is a perspective view of a device having RJ-45 ports and dongles having TP connectors;

FIG. 1B is a perspective view of a dongle having first and second parts that can be separated subsequent to writing data;

FIG. 1C is a perspective view of a dongle having a recessed TP connector;

FIGS. 2A and 2B are a block diagrams of read-only/read-write embodiments of the invention;

FIGS. 3A and B are graphs illustrating the generation of the ID-discovery pulse;

FIG. 4 is a block diagram of the memory transmit chip;

FIG. 5 is a flow chart depicting the steps performed by an embodiment of the invention;

FIG. 6 is a block diagram of a read/write embodiment of the invention;

FIGS. 7 and 8 are diagrams depicting authentication protocols implemented utilizing an embodiment of the invention.

### DETAILED DESCRIPTION OF THE INVENTION

Reference will now be made in detail to various embodiments of the invention. Examples of these embodiments are illustrated in the accompanying drawings. While the invention will be described in conjunction with these embodiments, it will be understood that it is not intended to limit the invention to any embodiment. On the contrary, it is intended to cover alternatives, modifications, and equivalents as may be included within the spirit and scope of the invention as defined by the appended claims. In the following description, numerous specific details are set forth in order to provide a thorough understanding of the various embodiments. However, the present invention may be practiced without some or all of these specific details. In other instances, well known process operations have not been described in detail in order not to unnecessarily obscure the present invention.

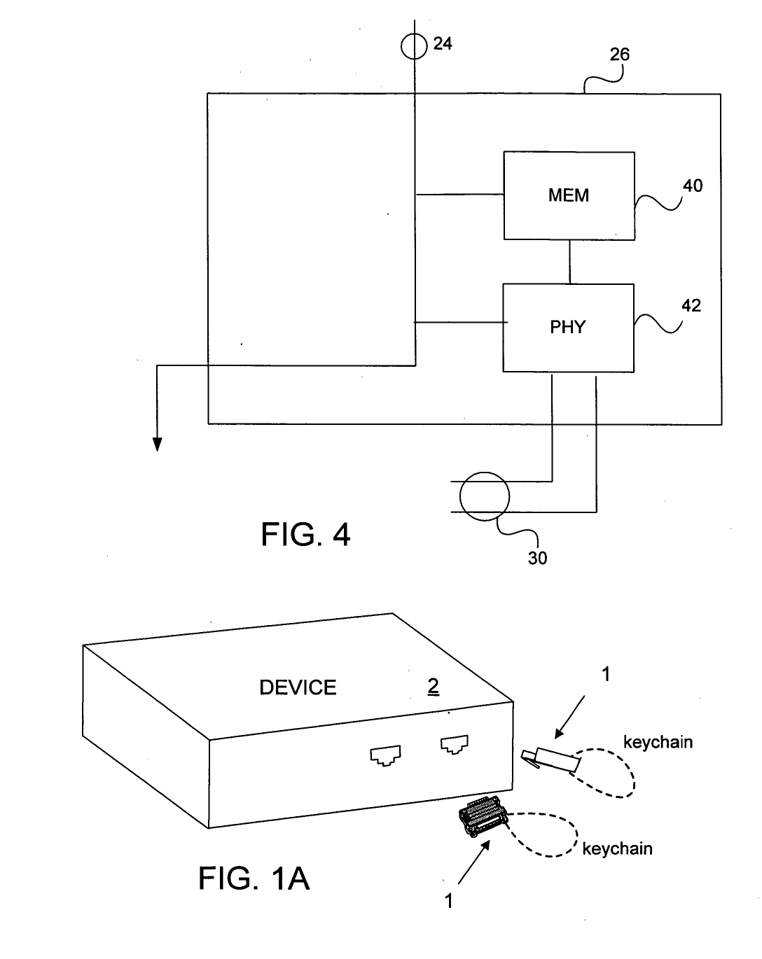

An embodiment of the invention will now be described that is a simple technique, which is as intuitive as inserting a car key into a lock. As depicted in FIG. 1A, the embodiment uses a dongle 1, which is a hardware device about the size of a car key that is inserted into a port of a device 2, in this embodiment an Ethernet port, to bootstrap security between two devices, such as devices on a home network, enterprise network, or between devices on an enterprise network and a home network.

FIG. 1B depicts an embodiment of the dongle 1 where the dongle may have dual circuitry and memory 3 and 4 for redundancy enclosed within a housing. Once the dongle is activated or powered, any memory writes are delivered to dual sets of memory that exist in a dual key-chain arrangement allowing the user to unplug one and keep it for backup purposes. The circuitry and memory 3 and 4 of the two parts of the dongle 1 are coupled by a connector which passes information written to a twisted pair (TP) connector 5 or 7, plugged into the port of the device, to the circuitry and memory not connected to the device. The connector allows the two parts of the dongle to be separated after data is transferred to the memory on each part of the dongle.

FIG. 1C depicts a dongle having the TP connector recessed to prevent damage. A push button 8 causes the TP connector to extend.

The embodiment includes a device that plugs into an Ethernet port but is not a complete Ethernet device. The device includes an Ethernet PHY but does not include MAC (Media Access Control) or LLC (Logical Link Control). The device does not have an included power source and derives its power from the Ethernet port of the host. The dongle of this embodiment has the following features and components:
1. An Ethernet connector, such as an RJ-45 connector;
2. Circuitry to capture power from the Ethernet host port;
3. A storage and delivery system that typically will store at least 128 bits; and
4. An ability to withstand up to 48V if applied by mistake.
5. The dongle may be powered by inline power means, presenting a common mode identity network similar to the 802.3af (Power over Ethernet (PoE)) 25 k resistor and a special class to identify itself. Once the dongle accepts the PoE 48V, local power generation to supply its circuitry may be used.
6. The dongle may present one or more single-pair identity networks across one or more pairs, and the switch may reduce the source impedance from 100 ohm to 1 ohm or less in order to supply ac signals to help the dongle use the ac signal resembling data to generate local power to help reduce the cost of power circuitry.
7. Any combination of single-pair and common mode differential identity networks and power acceptance and generation may be used.

In this embodiment, the dongle has a microchip to store and transmit the data, and has diodes and capacitors to present an identity network of resistors and diodes to enable the PHY in the host to recognize an attached dongle and power it.

The dongle of this embodiment uses diodes and a capacitor to make a power supply out of the 5V that the Ethernet Host provides. This power supply serves to power the delivery of data using continuous pulses to the Host.

In the simplest embodiment, the dongle memory is read-only and the dongle is shipped with a device where both device and dongle contain the same data. In this embodiment, the dongle serves only to convey the data from the device to another device through its Ethernet interface, which is modified to detect a dongle and process its signals as described below. Signals used to share information with the Host may be standard Ethernet i.e. (regular Ethernet packets) auto-negotiation FLPs (or fast link pulses) and any proprietary signals attenuated in amplitude to help reduce the power consumption while insuring proper delivery of data.

For example, in the scenario described above, the video library device could be shipped with a dongle, each holding secret security data. When the user wants to access video data from the video library to the television the dongle would be inserted into an Ethernet port on the television. The television could then use the secret data in the dongle to answer a challenge from the video library device.

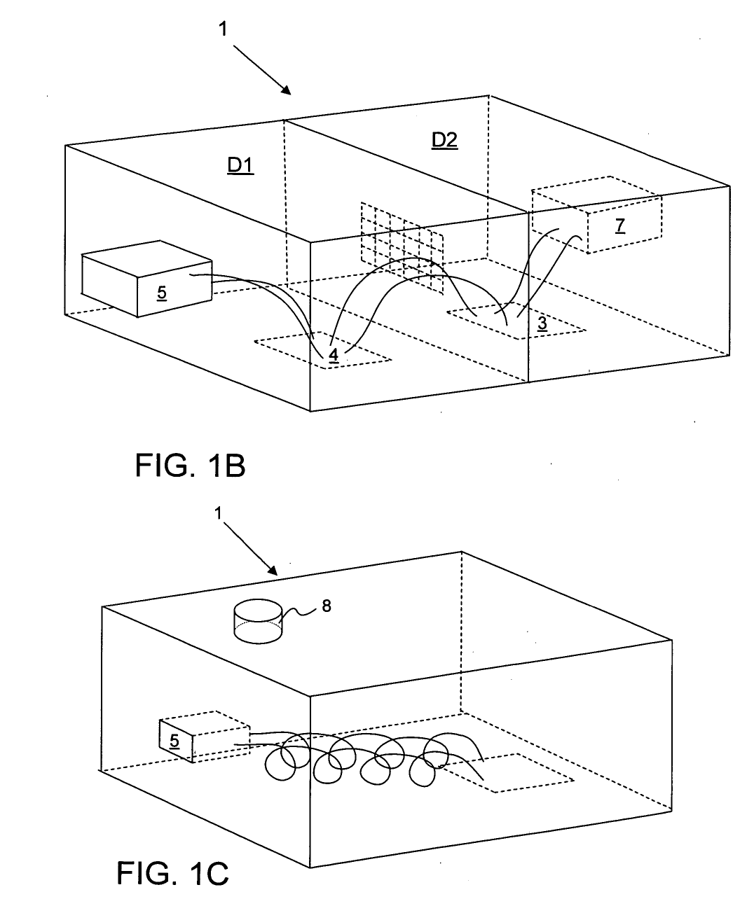

FIGS. 2A and 2B are block diagrams of a read-only or read-write embodiment. In FIG. 2A an Ethernet host port 10 includes a modified host port PHY 11 that generates an ID-discovery pulse when a connector is inserted into the Ethernet Host port and host-side transmit and receive transformers 12 and 13. The dongle 1 has a receive path 20 which includes a receive transformer 22, and a power supply circuit 24 that converts a received AC signal into DC, with the receive path 20 coupled to the receive side of a Memory Transmit chip 26. The receive transformer 22 allows the transmit chip to either receive and/or transmit data.

Also, incoming AC power pulses intended to deliver power may be encoded in a similar fashion to that of 10 BASET or some other proprietary mode so that a buffered input into the memory and PHY chip allows data and not just power to be supplied over this receive path 20.

As depicted in FIG. 2A, the dongle may include a common mode identity network 27 that allows the dongle to receive power from a host port that complies with the 802.3af Power over Ethernet (PoE) standard.

The dongle 1 has a transmit path 30, which includes a single pair identity network 32, and a transmit transformer 34 with the transmit path coupled to the transmit side of the Memory Transmit Chip 26. The receive and transmit transformers protect the dongle circuitry from a 48 volt shock if the dongle is plugged into the wrong port. All the circuit elements on the dongle may be mounted on a printed circuit board with traces that connect the various circuit elements. The interface between the dongle and the host can be a TP connector and RJ-45 socket. An 802.3af compatible dongle may avoid using the single pair identity networks to lower cost. Also the Host may use the classification of an 802.3af device to limit the current to a much lower value than specified in the 802.3af standard to keep the power delivered under control and limit damage under a fault condition. For example, the Host may opt to limit such current to 1 Watt or less, which is not currently enabled in the standard.

FIG. 2B depicts exemplary AC to DC circuitry and single-pair identity networks 24 and 32. The AC to DC circuitry 24 includes a diode bridge and capacitor. The single-pair identity circuit 32 includes a resistor/Zener (or a low capacitance zener equivalent circuit, since a low threshold zener may have excessive capacitance associated with it) diode voltage clamp.

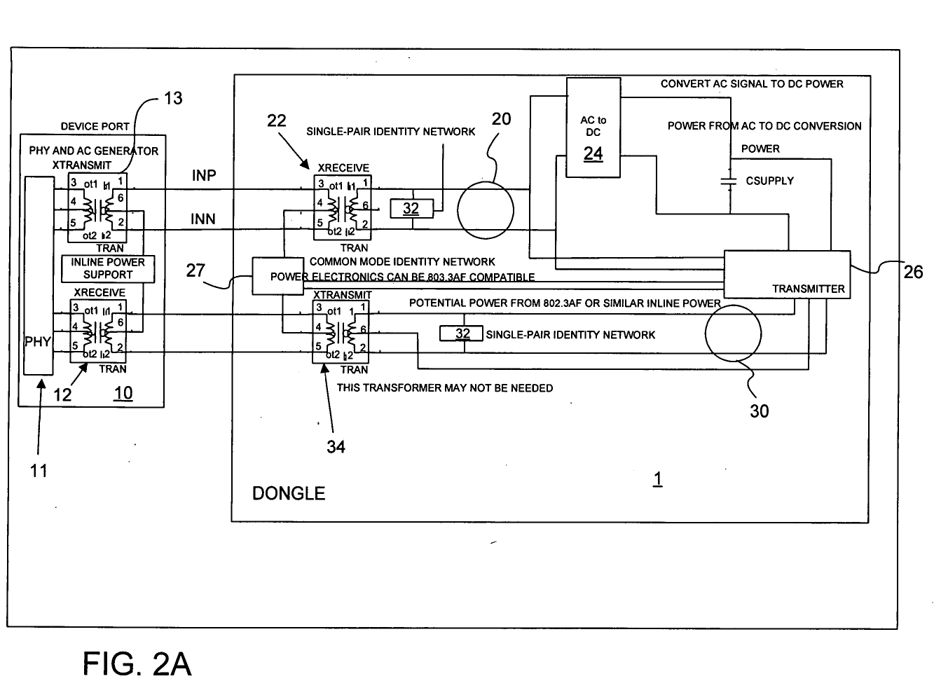

The PHY 11 on the Ethernet host port 10 is modified on the Ethernet host to test for a single-pair identity network as depicted in FIGS. 3A and B. In this example, to illustrate the concept, the modified host PHY 11 generates an ID-discovery pulse with a voltage swing of 3 V peak as depicted in FIG. 3A. The identity network 32 clamps the voltage on the positive and the negative swing to 2.6 V (across nodes PCL and PCN or nodes P and N) to generate the ID-discovery pulse depicted in FIG. 3A. In FIG. 3A, the 6 v peak-peak signal that may be one or more cycles of a 5 Mhz sine wave and can change in amplitude and or frequency to scale with the zener equivalent circuit is shown at the source coming from device 10. In the presence of the clamping network, the voltage is attenuated to 5.2 v peak-peak as shown in FIG. 3B and that attenuation is measured in 10 at the primary side of receive transformer 12 by circuitry in the host port Phy chip 11 across nodes P and N. The host-port Phy chip 11 generates the discovery pulses and measures its own transmitted signal for a drop in voltage to detect the presence of the identity network. If the voltage is 6 v peak-peak then no clamping network is present. Although a 6 v peak-peak amplitude is shown for a zener threshold in addition to the forward voltage drop of the second zener inline and the drop across the 20 ohm total resistance in the network to make up the total clamping voltage, different diode based clamps, equivalent zener circuits and combination of amplitude and polarities may apply and would work as well. The clamping action of the identity network 32 does not affect data signals output from the Memory Transmit chip 26 which have a voltage swing lower than the clamping voltage. For example, in this embodiment the signal voltage swing is about 0.5 V to 1.0 V.

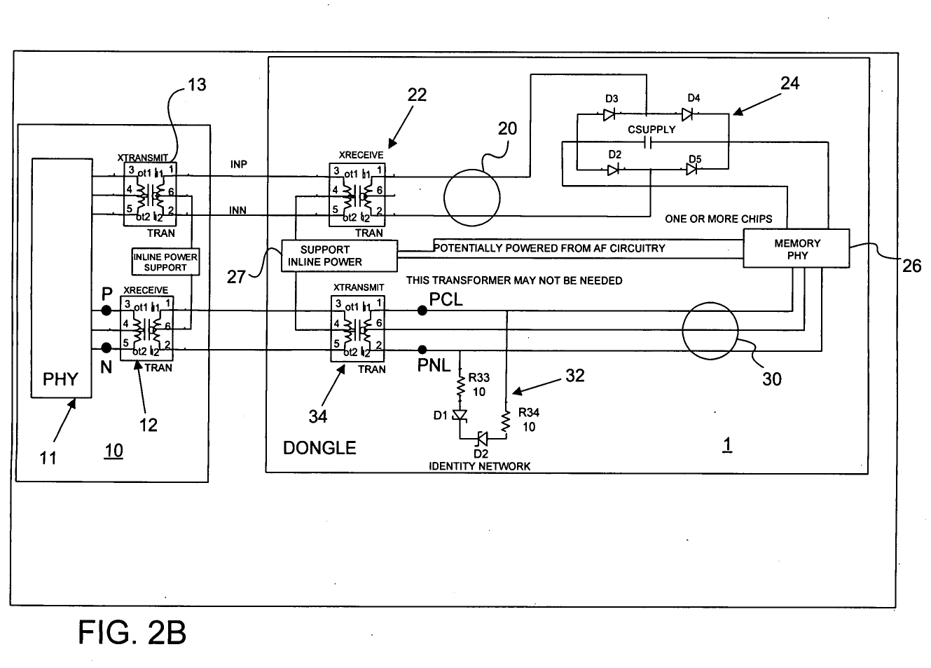

FIG. 4 is a block diagram of the Memory Transmit chip 26. The Memory Transmit chip 26 includes a non-volatile memory 40 coupled to a modified PHY 42. Both the non-volatile memory 40 and PHY 42 are coupled to receive power from the power supply circuit 24 (FIG. 2A) ) or from the inline power circuitry if the dongle is configured to support inline power where a dongle may be configured to support both. FIG. 4 depicts a memory transmit chip including a non-volatile memory and a PHY. However, different embodiments utilizing multiple chips, read-write memory, or a Field Programmable Gate Array (FPGA), etc. may be utilized to implement the functionality described.

In this way, the Ethernet host can determine when the dongle of the presently described embodiment is inserted in an Ethernet host port and the host supplies a 5 MHz (AC) signal resembling data to power the dongle. In standard PHYs a 100 ohm differential source is utilized. If the dongle is discovered by the ID sequence, the 100 ohm can be changed to 1 ohm to lower the source impedance to generate more AC power for the dongle. Thus, if necessary the PHY/AC generator on the host port 10 may deliver proprietary signals (amplitude and frequency) for power generation lowering the 100 ohm impedance to enable an increase in the power delivered to a dongle.

This 5 MHz signal is rectified by the power supply circuit in the receive path of the dongle to provide power to the Memory Transmit chip 26.

Following this action, if the host fails to receive pulses within a certain period of time, it repeats its test until it either receives pulses from a dongle or finds a valid Ethernet device.

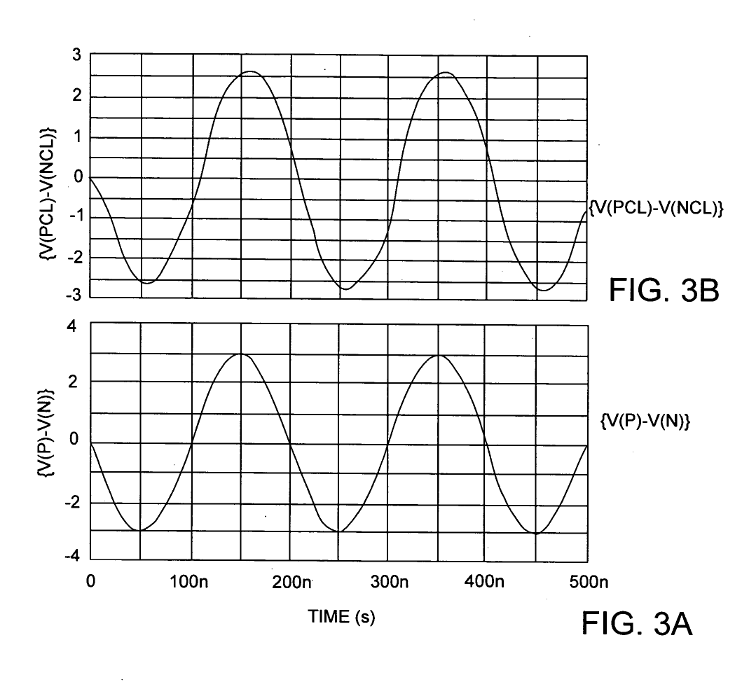

As depicted in the flow chart of FIG. 5, when correctly inserted into the host's Ethernet port and powered, the dongle emits 100 nsec pulses, and the host uses auto-negotiation logic to receive data from the dongle. Auto-negotiation utilizes the Fast Link Pulse (FLP) where an FLP burst is a sequence of 10 Base-T Normal Link Pulses (NLPs), also known as Link Test Pulses, which come together to form a message or “word”. The Auto-Negotiation protocol includes a Next Page function which allows devices to transmit additional information beyond their link code words.

In a simple embodiment, the string held in the read-only memory is 128 bits in length and is a secret from another device that the host receives into its memory to share the secret with the device. The dongle can recover a clock from the signal on the receive path and use it for transmitting its bits from memory. An embodiment uses the continuous IDLE code of a 10 BaseT switch interface for this purpose.

The memory may be selected to hold more bits to support other security protocols. For example, the Windows USB Smart Network Key, described above, can be a Wireless Wi-Fi WEP (Wireless Equivalent Privacy) key. Accordingly, the memory used in different embodiments of the invention would be selected to have a capacity to support different protocols, for example a WEP that utilizes a 24-bit initialization vector plus a 40, 104, or 232-bit key.

To effect the transfer of the data, the host PHY must further coordinate the reception of the ‘Next Page’ pulses as they are coming over the host receive pair to the host PHY in the host switch while the transmit pair of the switch continuously supplies 5 MHz 5 v peak-peak to power the dongle. The PHY can either interrupt to software or store the data over its MDIO (Management Data I/O) interface into local EEPROM (Electrically Erasable Programmable Read-Only Memory).

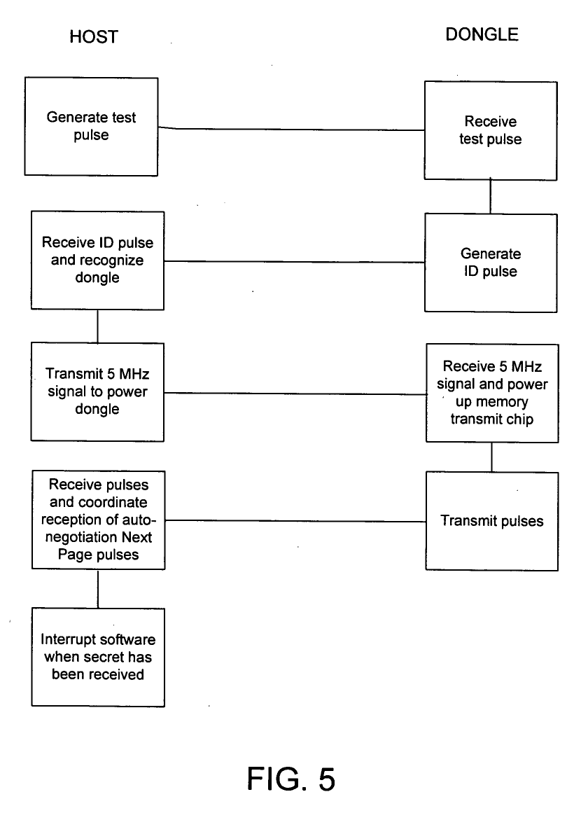

FIG. 6 depicts an embodiment that includes a read/write DRAM and transmit/receive PHY on the dongle 1 that allows new bit strings to be written to the dongle memory.

The circuit layout of the dongle is the same as in FIG. 2A with Memory Transmit chip 26 replaced with a Memory Transmit/Receive chip 50. The Ethernet Host includes a Tx/Rx portion of the PHY coupled to the receive path of the dongle. The data to be written to the dongle memory is transmitted over the receive path 30 of the dongle.

Alternatively, the data to be written to the Memory Transmit/Receive chip 50 could be input on the receive path 20 of the dongle by modulating the 5 MHz signal to carry the input data. The receive path is coupled to the inputs of the memory by a high-impedance buffer so as to not load the incoming signals and reduce the power available.

In the embodiment depicted in FIG. 6, the initialization of the secret onto the dongle can happen dynamically and under user control when the user writes the secret from one device and conveys it to a second device using the dongle. In this case, both devices must have Ethernet ports with modified drivers by which to read and to write the secret.

This embodiment has a small amount of memory to store a shared secret, such as a 128-bit string. A more elaborate embodiment can store more information such as a hash chain. It is known in the art of computer security for an authenticating device to store a one-way hash chain g_i having the property of g_i=H(g_i-1), and g_{—}0 is set to a random constant. In systems such as S/Key, an authenticator device that receives a value, g, from an authenticating device can challenge the authenticating device to produce another value, g′, such that g=H(g′). When the function H is known to be hard to invert, a device can prove that it is the same device that provided a value g when it subsequently provides the generating value g′, which produces g=H(g′).

In an embodiment, the Host has means, such as an LED, to signal the successful transfer. A Host may do a read-back after a memory write to verify the content before declaring a successful transfer with an LED flashing. If a failure of transfer takes place an LED on the dongle may be flashed to indicate an error and alert the user. Such a transfer occurs while the dongle is attached to the port and no standard Ethernet device is attached. The interface that connects to the dongle must be disconnected from the network and all processing ceases when the dongle is no longer attached.

The Host processing includes reception of the data and the execution of a protocol between the switch and another device that shares the received data. In one embodiment, the protocol is a challenge/response protocol between the host and remote device, which are connected together on a network (i.e. through an interface other than the one which connects the dongle).

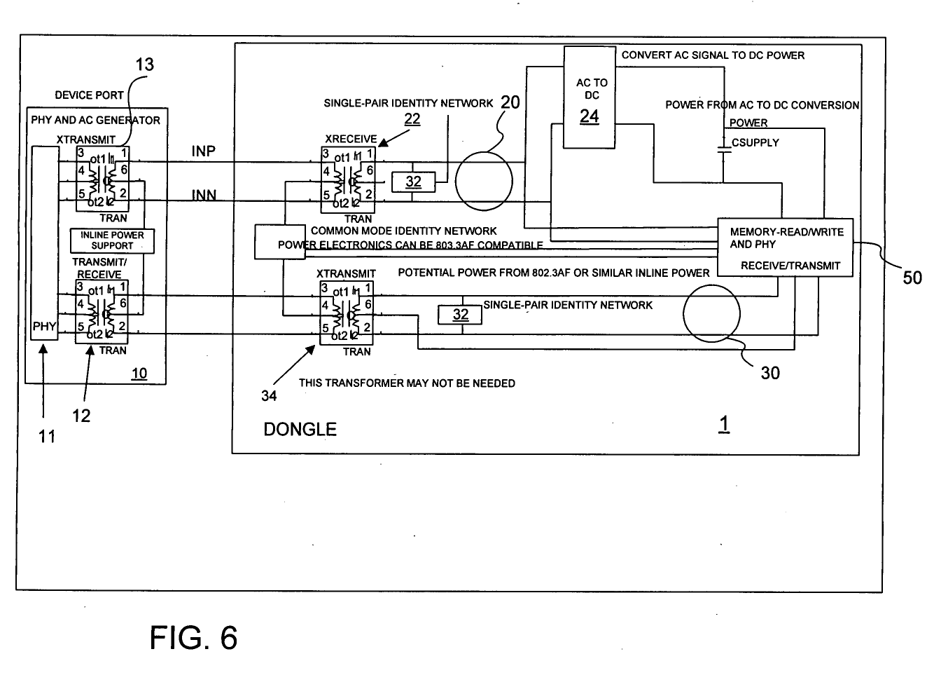

A protocol for the embodiment that uses a read-only dongle in which the secret is written to the dongle by a manufacturer and shipped to the user with the device will now be described. In this embodiment, the device has a pre-shared secret in non-volatile storage that matches the secret on the dongle; this device does not need to have an Ethernet port. It could be a wireless device, for example, and is labeled as the “Petitioner” in FIG. 7.

There is a dongle associated with the Petitioner that a human user inserts into a network device, which has an Ethernet port with a modified Ethernet driver to read the dongle. The network device, labeled “Registrar” in FIG. 7, responds to a challenge from the Petitioner when the human user powers up the Petitioner device as shown in FIG. 7. If the challenge/response protocol completes successfully, both Petitioner and Registrar have each proven that the other is the only device in possession of the secret and can establish a security association, which may be established by an Internet Key Exchange (IKE) protocol exchange in an embodiment. Following this, the two devices can engage in a secure transaction, such as a certificate or secret key enrollment exchange.

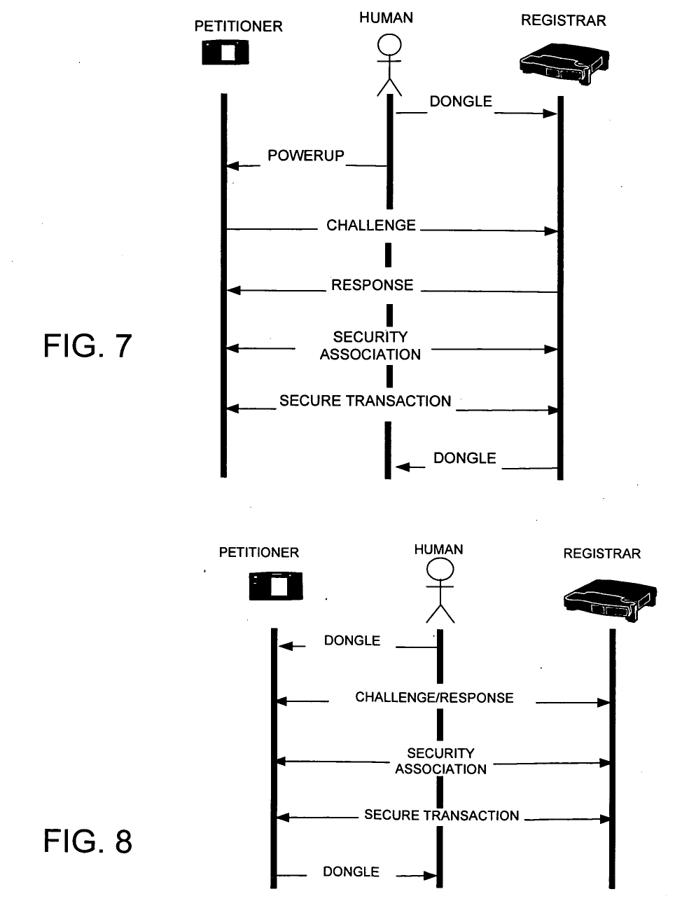

The dongle may be applied to either the Petitioner or Registrar, and either may initiate the challenge/response protocol, and these alternative embodiments are depicted in FIG. 8.

The invention has now been described with reference to the preferred embodiments. Alternatives and substitutions will now be apparent to persons of skill in the art. For example, alternative techniques for powering the dongle such as a battery could be utilized. Additionally, as understood in the art, connectors other than RJ-45 could be utilized to practice the invention. Further, the voltages levels depicted in FIGS. 3A and B and of the peak to peak signal voltage levels are given by way of example, not limitation, and other voltage levels and clamping network topologies may be used as is known in the art. Accordingly, it is not intended to limit the invention except as provided by the appended claims.

What is claimed is:

1. A non-ethernet device for conveying data through an ethernet port comprising:
a housing having an opening;
an ethernet port connector disposed in the opening;
an ethernet physical layer device (PHY) and memory device operatively connected to each other and to the ethernet port disposed within the housing;
a power supply circuit, disposed within the housing, operatively connected to the ethernet port connector, the memory, and the PHY that accepts power from the ethernet port connector and supplies power to the PHY and memory; and
an ID-discovery circuit, disposed within the housing, that allows an Ethernet host to determine whether the non-ethernet device or an ethernet device is coupled to an ethernet port of the host.

2. The non-ethernet device of claim 1 where the ID-discovery circuit comprises:
a clamp for clamping a voltage swing of an ID-discovery pulse to a selected level.

3. The non-ethernet device of claim 1 where the power supply circuit comprises:
a diode capacitor circuit for rectifying a received signal resembling data.

4. The non-ethernet device of claim 1 where the power supply circuit accepts common mode power from a Power over Ethernet port.

5. The non-ethernet device of claim 1 where the host ethernet port is an RJ-45 port and the ethernet port connector is a twisted-pair connector.

6. The non-ethernet device of claim 1 where:
the ethernet host includes an ethernet port that generates the ID-discovery pulse modified by the ID-discovery circuit to allow discovery of the non-ethernet port when connected to the ethernet port.

7. The non-ethernet device of claim 1 where the ethernet host includes power sourcing circuitry for supplying power to the power supply circuit via the ethernet port connector.

8. The non-ethernet device of claim 1 where:
the memory is non-volatile memory having data stored by the manufacturer.

9. The non-ethernet device of claim 1 where:
the memory is read/write memory that is programmable by a user.

10. The non-ethernet device of claim 1 where:
no ethernet link logic control is included within the dongle.

11. The non-ethernet device of claim 1 where:
the power supply circuit includes circuitry for changing impedance, frequency and amplitude levels in the Host to increase the AC based power delivered based on the discovery of said single pair identity network, a specific 802.3af unique class or similar and or a combination of both identity networks.

12. The non-ethernet device of claim 1 where:
the power supply circuit includes circuitry for supplying common mode power to the recognized device.

13. A device including an ethernet port, with the ethernet port comprising:
an ID-discovery pulse generating circuit for generating an ID-pulse when a device is connected to the ethernet port to identify a non-ethernet device connected to the port; and
an inline power support circuit for supplying power to an identified non-ethernet device.

14. A method, for receiving data from a non-ethernet device coupled to an ethernet port comprising:
supplying an ID-discovery pulse to a device connected to the ethernet port;
analyzing a returned ID-discovery pulse from a connected device to determine whether the connected device is a recognized device;
supplying power to a recognized device; and
utilizing an auto-negotiation policy to exchange data with a recognized device.

15. The method of claim 14 where the step of supplying power comprises:
transmitting an AC data signal to the recognized device.

16. The method of claim 14 where the step of supplying power comprises:
supplying common mode power to the recognized device.

17. The method of claim 16 where the step of supplying power comprises:
lowering the current limit in the Host below that allowed in the 802.3af specification for common mode inline power to the recognized device resulting in a pseudo-compliant 802.3af mode of power deliver.

18. The method of claim 14 where the steps of supplying and analyzing an ID-discovery pulse comprise:
generating an ID-discovery pulse having a voltage swing of greater magnitude than the voltage swing of a data pulse; and
determining whether the voltage swing of the returned ID-discovery pulse has been clamped to a selected amplitude.

19. A system, for receiving data from a non-ethernet device coupled to an ethernet port comprising:
means for supplying an ID-discovery pulse to a device connected to the ethernet port;
means for analyzing a returned ID-discovery pulse from a connected device to determine whether the connected device is a recognized device;
means for supplying power to a recognized device; and
means for utilizing an auto-negotiation policy to exchange data with a recognized device.
